(19) United States
(12) Patent Application Publication
(10) Pub. No.: US 2011/0317001 A1
(43) Pub. Date: Dec. 29, 2011

(54) MULTISENSOR ARRAY FOR THE OPTICAL INSPECTION AND SORTING OF BULK MATERIALS

(75) Inventor: Robert MASSEN, Ohningen (DE)

(73) Assignee: BAUMER INSPECTION GMBH, Konstanz (DE)

(21) Appl. No.: 13/165,045

(22) Filed: Jun. 21, 2011

(30) Foreign Application Priority Data
Jun. 23, 2010 (DE) 10 2010 024 784.7

(51) Int. Cl. H04N 7/18

(52) U.S. Cl. 348/91; 348/E07.085

(57) ABSTRACT

A Multisensor array optically inspects and sorts bulk materials into different fractions, in which the bulk material stream is detected from a short distance compared to the width of the bulk material stream with at least two identical camera and lighting modules arranged adjacent to each other. The width of the image of the cameras is smaller than the width of the bulk material stream. The image sensors and lighting devices are limited to the range of the wavelengths of 380 nm to 1,000 nm covered by CMOS and/or CCD image sensors. Each camera is connected by a mechanical bracket and is equipped with at least one and preferably with a set of linearly lighting semiconductor light sources, which emit in a narrow band and are pulsed synchronously with the line frequency of the camera. The linearly lighting light sources can be replaced by a changing mechanism of the bracket, which mechanism is connected to the camera, to other light sources, especially ones having different system parameters. The actuating signals of the lighting sources pulsed synchronously with the line cycle of the image sensors can be generated by an electronic device according to a variable synchronization diagram, which can be optimized for the discrimination of the fractions of the bulk material stream. The signals of the camera or cameras are analyzed by at least one image computer by pattern recognition and classification for recognizing, assigning and rating the particles of the at least two fractions. Timely ejection signals are generated by a control device by real-time image processing operators in order to remove particles of at least one fraction to be removed from the bulk material stream with ejectors.

### CROSS REFERENCE TO RELATED APPLICATIONS

This application claims the benefit of priority under 35 U.S.C. §119 of German Patent Application DE 10 2010 024 784.7 filed Jun. 23, 2010, the entire contents of which are incorporated herein by reference.

### FIELD OF THE INVENTION

The invention relates to sensors for the inspection and sorting of bulk materials into different fractions. The invention also relates to a process for the inspection and sorting of bulk materials into different fractions.

### BACKGROUND OF THE INVENTION

The task of sorting bulk material streams into different fractions (size, weight, material properties, shape properties, surface properties) is performed by means of physical separation processes such as screens, cyclones, chutes, floating/sinking tanks, vibration conveyors, etc., in the classical process technology for processing bulk materials such as granular foods, minerals, crushed waste parts in recycling and the like. These techniques, which are designed in many different ways, are usually designed only for a certain task and cannot therefore be flexibly adapted to different bulk materials.

They also usually have limited suitability for recognizing pure surface properties such as color(s) and surface textures. Different material properties, for example, the type of plastic in case of crushed plastic containers, are recognized only indirectly based on differences in density. The traditional process technology based on bulk material streams is usually also incapable of performing sorting according to a plurality of material types present simultaneously in the plant and to measure a plurality of properties, for example, the color and shape of rice grains and to sort them accordingly into certain fractions.

It has been known since at least the 1980s that camera systems can be used for the optical, contactless detection of a bulk material stream, for the optical, simultaneous measurement of the individual particles of the bulk material stream from the rapid sequence of images by means of pattern recognition methods according to different criteria in full motion and for subsequently sorting out the particles of the bulk material stream into different fractions via pneumatic ejectors or fast-acting mechanical switches.

Particles of bulk material or components of bulk material are defined here, for example, as fibers, grains, flakes, metal chips, pieces, chips or chaff.

A review of the more recent state of the art from the viewpoint of users can be found in the document “J. Eberhardt, R. Massen: The Optical Screen: Multisensor image processing for sorting bulk materials. VDMA Infotag “Automatisierungstechnik fur Schüttgüter—Kernthematik im Maschinen-and Anlagenbau,” Sep. 10, 2008. VDMA Haus, Frankfurt/Main.”

Despite increasingly faster dot matrix or line scan cameras and more modern lighting systems, such as high-performance pulsed LED lines, there are still a number of unsolved or economically poorly solved problems in the “optical screen” technique, i.e., the inspection and sorting of particles of bulk material streams into fractions with preset properties by means of cameras and high-speed ejectors. We will hereinafter use the term bulk material stream “particle” for all parts that form the bulk material stream, for example, the individual rice grain, the individual cutlet, the individual mineral stone, etc. The most important obstacles to a wider use of the camera systems for sorting bulk material streams are today:
The relatively bulky design of these plants, comprising the separation of the bulk material stream into individual particles and feeding into the image field of the inspection camera.

Usually, great widths of bulk material stream (500 mm to 5,000 mm) are detected optically with a few high-resolution line scan cameras from a great distance, which have an approximately telecentric view as a result. This is the only possibility for overcoming the problems of vignetting, achromatic distortions, and image angle-dependent image sharpness (cf., e.g., Sorting Plants of the Firm of Buhler-Sortex, www.buhlergroup.com, product line Sortex F).

These large constructions are very expensive especially because of the required mechanical stability of the optical components (orientation of the camera and lighting).
camera-based sorting systems are designed relatively specifically for a small group of tasks each, because the cameras, lighting and ejection systems used must be exactly adapted to the physical properties of the bulk material stream particles.
Systems for sorting granular foods use 3-channel or 4-channel color line scan cameras (RGB or RGB+NIR). Maintaining the white light line illuminations, reaching up to 5 m in length, with a stable color over an industrial temperature range presents a special difficulty here.
Systems for sorting plastic waste use imaging NIR spectrometers (hyperspectral imaging in English), which are based on InGaAs detectors. This is a cost-intensive technology and requires broad-band light sources, usually halogen lamps, which have a low efficiency and generate a large amount of interfering heat.

In the document Jia et al. “Detection of foreign materials in cotton using a multi-wavelength imaging method,” Meas. Sci. Technol. 16, pp. 1355-1362, Institute of Physics Publishing, 2005, the authors describe a laboratory set-up comprising a black-and-white camera, a holder for a sample of cotton fibers and various contaminants such as jute threads, plastic twines, as well as a lighting field with LED of a preset narrow-band emission spectrum. They show that in case of a combination of a number of images at a particular emission spectrum selected, the individual images can be composed into a brightness image, in which the contrast between cotton and the contaminants is markedly greater. This is compared to a usual broad-band white light illumination. However, no arrays or embodiments are made for a generally valid, cost-effective inspection and sorting of bulk material.

### SUMMARY OF THE INVENTION

There is therefore a technical and economic need for cost-effective, camera-based inspection and sorting systems, which, having a compact design and using a large number of simultaneously operating, identical modules composed of inexpensive cameras and lighting means, optically detect the bulk material stream from a short distance and which can be adapted to greatly different materials and sorting tasks by changes limited to a few mechanical and optical components (modular generic bulk material stream sorting system).

According to the invention, this result is accomplished, summarized in a simplified manner, by the combination of a plurality of principles, some of which are known in themselves in the technology. Instead of from a great distance by means of high-resolution black-and-white and color cameras and complicated optical systems, the bulk material stream is detected from a short distance with a plurality of identical, inexpensive black-and-white cameras with simple optical systems, preferably with dot matrix image sensors read line by line over a few lines in the range of the wavelength ranges of approx. 380 nm to 1,000 nm covered by inexpensive CMOS and/or CCD image sensors. The distance of the camera is shorter than the width of the bulk material stream.

The overall size is greatly reduced by this principle and the requirements on the mechanical stability and accuracy of the design is likewise greatly reduced. This reduces the costs of the mechanical construction and makes it possible to use more compact built-in parts, so that the costs of integrating the sorting into a process line drop greatly as well.

Instead of the usual lighting with broad-band, highly stable white-light linear lighting means, the bulk material stream is lit by means of a set of a plurality of short, narrow-band semiconductor light sources, which are associated with every individual camera and operate predominantly synchronously with the line frequency of the camera, and these short light sources emit light each in a different wavelength range and can be easily replaced mechanically for adaptation to different sorting tasks and materials to be sorted.

Due to this principle, only short and hence inexpensive line lamps of a comparatively low power are needed, whose heat dissipation can be accomplished in a simple manner. Due to the limitation to narrow-band semiconductor light sources, the spectral constancy can be guaranteed and achieved in a markedly simpler manner in an industrial environment than in case of conventional broad-band fluorescent or halogen lamps, in which the radiometric constancy covers a broad range of wavelengths from approximately 380 nm to 1,000 nm.

The mean time between failures (MTBF) is approximately 500 times longer in case of a short line with, for example, only 20 LEDs arranged in a row than in case of a classical mode of operation with long LED lights with up to 10,000 individual LEDs. The maintenance costs for the principle according to the present invention are thus also considerably lower than in the state of the art, in which the failure of one of the 10,000 LEDs of a long linear light requires the removal, repair and mechanically accurate reinstallation of a large number of components.

The lighting sources (lighting units) can be replaced with other lighting sources with different wavelength ranges and/or different geometric radiation characteristics (optical axis, beam lobe description) and/or a different structuring of the course of light along the longitudinal axis of the linear light.

The lighting diagram over time of the N pulsed semiconductor light sources and/or the emitted light output of each of the N pulsed lighting means is set such that the radiometric contrast between the individual fractions and from the background is maximized in the generated 1- to N-channel line images.

The actuating signals of the lighting sources pulsed synchronously with the line cycle of the image sensors can be generated by means of an electronic means according to a variable synchronization diagram, which can be optimized for the discrimination of the fractions of the bulk material stream.

A few optimally positioned narrow-band wavelength ranges and the corresponding light powers for the narrow-band linear lighting means are determined by means of mechanical learning processes on the basis of typical samples of bulk material stream to be sorted during the phase of adaptation of the generic bulk material stream module such that a set of line images, which set bring about the best possible discrimination of the fractions of the bulk material stream from each other as well as from the background, is derived from the bulk material stream with a small number of typically 2 to 5 linear lighting means switched on one after another in the line cycle.

In another, preferred embodiment of the present invention, each module, comprising a camera and pulsed narrow-band linear lighting means, also comprises an associated array of fast-acting ejectors, which are mechanically connected to the module, preferably highly dynamic pneumatic valves, for sorting out the particles of the bulk material stream into the desired fractions, so that a module comprises a compact, integrated unit comprising a camera, n pulsed linear lighting means and a short strip with ejectors. Further each module may include a computer or processor for processing camera signals and a control for controlling the fast-acting ejectors or associated ejectors based on the processed camera signals.

This compact arrangement in one module of image detection, n narrow-band lighting means and associated ejectors has the significant advantage over the state of the art that a velocity profile of the particles, which differs at right angles to the bulk material stream, does not have to be individually compensated for each ejector if the ejectors are actuated accurately in time.

Because of the relatively narrow observation window of a module at right angles to the bulk material stream, it can be assumed that the mean velocity of all particles and hence all ejectors of one module can be actuated within this window with the same dead time between image recording and blow-out through the ejector.

An additional measurement of the velocity profile, as it is described, for example, in the document “The Optical Screen: Multisensor Image Processing for Sorting Bulk Materials,” thus becomes unnecessary.

In summary, such a highly modular design makes possible, because of the scale effect, a substantially more cost-effective design than the current large and special systems, and hence a better penetration of the process technology by the “optical screen” technology than has hitherto been possible.

The present application describes the present invention based on a simple and especially clear example of the inspection and sorting of crushed wood waste from the renovation of buildings for obtaining chips of high quality for manufacturing high-quality wood fiber boards. The sorting task is carried in a simplified manner so as to obtain two fractions:
a) The sorting out of the foreign fraction of the painted and rotted wood particles and, accompanying this,
b) the production of the cleanest possible residual fraction for manufacturing high-quality boards for the furniture industry, indoor and outdoor construction as well as for industrial boards, for example, panels.

This application is meant only as an explanatory example rather than a limiting application. The express goal of the present invention is rather to keep the number of elements of an optical sorting system, which remain identical, as high as possible thanks to a highly modular design of the hardware and software even in case of application to different material streams and different sorting tasks and thus to make retrofitting possible as cost-effectively as possible. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is a side view showing a general design according to the state of the art of an optical inspection and sorting system for sorting particles of a bulk material stream into two fractions;

FIG. 1b is a top view showing the same general design as FIG. 1a;

FIG. 2a is a side view showing a general design according to the present invention;

FIG. 2b is a top view showing the general design of an optical inspection and sorting system according to the present invention;

FIG. 3 is a schematic view showing as an example the sorting of a bulk material stream of waste wood particles into the two fractions;

FIG. 4a is an explanatory view showing an example of the separation of types of particles of interest through one of a combination of optical effects, which are brought about by the different types of lighting;

FIG. 4b is an explanatory view showing an example of the separation of types of particles of interest through another of a combination of optical effects, which are brought about by the different types of lighting;

FIG. 4c is an explanatory view showing an example of the separation of types of particles of interest through another of a combination of optical effects, which are brought about by the different types of lighting;

FIG. 5 is a top view illustrating a pulsed lighting diagram of the bulk material stream by rapid switching synchronized with the line cycle of the camera between three lighting sources;

FIG. 6 is a top view illustrating an alternative lighting diagram;

FIG. 7 is a graph illustrating optically maximally discriminating lighting intensities according to the present invention;

FIG. 8 is a schematic view illustrating an optically maximally discriminating active background according to the present invention; and

FIG. 9 is a schematic view illustrating general aspects of the present invention

### DESCRIPTION OF THE PREFERRED EMBODIMENTS

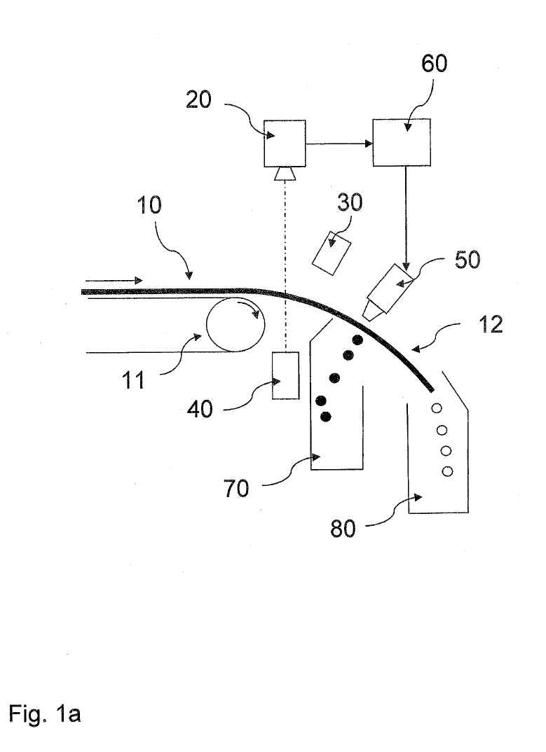

Referring to the drawings in particular, FIG. 1 a shows in a side view the general design according to the state of the art of an optical inspection and sorting system for sorting particles of a bulk material stream into two fractions. This sorting system comprises a feeding of the particles 10, separated from each other, by means of a high-speed conveyor 11, the discharge of the particles into a flight section 12, in which a line scan inspection camera 20 observes the bulk material stream in the incident light of a linear lighting means 30 and against a defined background 40, an array of pneumatic ejectors 50, which are arranged closely adjacent to one another and which, actuated by the image computer 60, deflect particles possessing defined properties from the natural flight path and bring them into the container 70 of fraction B of the “bad” parts, whereas fraction A of the “good” parts lands in container 80 along the undisturbed flight path.

FIG. 1b additionally shows, for better understanding, the design from FIG. 1a from the top in a top view and the sorting system for sorting particles of a bulk material stream into two fractions. FIG. 1b shows a feed of the particles 10, which are separated from each other, by means of a high-speed conveyor belt 11, the lighting means with a linear lighting device 30, and the image recording means with a line scan camera 20, which detects the bulk material stream 10 over the entire product width. A linear array of pneumatic ejectors 50 are arranged closely adjacent to one another and, actuated by the image computer 60, deflect particles possessing certain properties from the natural flight path 12 and bring them into the container 70 of fraction B of the “bad” parts, whereas fraction A of the “good” parts lands in container 80 along the undisturbed flight path.

In a side view, FIG. 1a shows the general prior-art design of an optical inspection and sorting system for sorting wood particles into two fractions, comprising a feeding of the particles 10, which are separated from one another, by means of a high-speed conveyor 11, the discharge of the particles into a flight section 12, in which a line scan inspection camera 20 observes the bulk material stream in the incident light of a linear lighting means 30 and against a defined background 40, an array of pneumatic ejectors 50, which are arranged closely adjacent to each other and which, actuated by the image computer 60, deflect particles possessing certain properties from the natural flight path 12 and bring them into the container 70 of fraction B (for example, the “bad” parts), whereas fraction A of the “good” parts lands in container 80 along the undisturbed flight path. The example is limited to the observation of the bulk material stream from only one direction, i.e., only one camera is used, which observes only the upper side of the flight path.

The expansion of such a sorting of the bulk material stream into a plurality of fractions by the use of a plurality of cameras, the observation of the bulk material stream from the front side and from the rear side, the special design of the feeding and separation of the particles as well as of the separating elements represent the state of the art and are documented, e.g., in the document cited first (“The Optical Screen: Multisensor Image Processing for Sorting Bulk Materials”).

For better understanding, FIG. 1b shows this optical inspection and sorting system for wood particles for sorting into two fractions, comprising a feed means for the particles 10, which are separated from one another, by means of a high-speed conveyor 11, the lighting means with a linear lighting means 30, the image recording with a line scan camera 20, which detects the bulk material stream 10 over the entire product width, a linear array of pneumatic ejectors 50, which are arranged closely adjacent to one another and which, actuated by the image processor, deflect particles possessing certain properties from the natural flight path and bring them into container 70 of fraction B of the “bad” parts, whereas fraction A of the “good” parts lands in container 80 along the undisturbed flight path.

Because of the known weaknesses of wide-angle imaging optical systems, such as lack of sharpness at the margin of the image, great chromatic distortions towards the margin of the image, partial mutual hiding of the particles at the margins of the image, etc., it becomes necessary due to the imaging of a bulk material stream, which often reaches a width of up to 5 m, onto only one or a few line scan cameras arranged next to each other to have a great distance between the camera and the object (approximately telecentric parallel imaging) and, associated herewith, a large overall size of the entire feeding, lighting and image recording system. However, as is known to the person skilled in the art of optics, the costs increase exponentially with increasing overall size of the optical system.

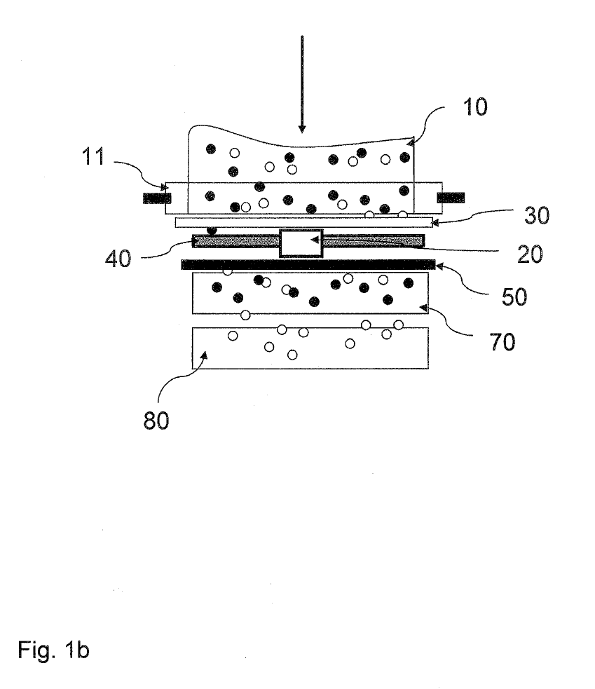

FIG. 2a shows a multisensor array system 500 according to the invention. The system 500 is based on a plurality of integrated camera and lighting modules 100. Each camera and lighting module 100 comprises a line scan inspection camera 200 and a lighting means 400. Advantageously, each integrated camera and lighting module 100 may also includes a processor and control module 600. The processor and control module 600 has an image computer 601 including an image processor for processing camera signals and a control unit 602 generating control signals to control one or more pneumatic ejectors 500. The processor and control module 600 also advantageously includes an electronic means 603 for generating actuating signals of the lighting sources pulsed synchronously with the line cycle of the image sensors. These actuating signals are generated by means of the electronic means 603 according to a variable synchronization diagram, which can be optimized for the discrimination of the fractions of the bulk material stream. The electronic means 603 comprises lighting actuating means. Pattern recognition methods as well as the lighting arrangements and the operation of the electronic means as the lighting actuating means are determined and optimized for the inspection and sorting task set in a preparatory learning phase on the basis of samples of the bulk material stream by means of methods of mechanical learning and pattern recognition.

The modules are positioned such that the bulk material stream of particles 10 is detected from a short distance D. The distance D is short compared to the width of the stream of bulk material (D is a distance less than the width of the bulk stream of particles 10).

FIG. 2b shows, in a top view, the general design according to the present invention of an optical inspection and sorting system or multisensor array system 500 for sorting particles of a bulk material stream into two fractions. The multisensor array system 500 comprises a feeding of the particles 10, which are separated from one another. With the deployment of a plurality of integrated camera and lighting modules 100, a large number of line scan inspection cameras 200 are arranged closely adjacent to one another, which each observe only a small section of the bulk material stream in the incident light of a short linear lighting means 400 associated with the camera 200. An array of ejectors 50, for example, a pneumatic ejector row 50, which has individual ejectors arranged closely adjacent to one another and which deflect, actuated by the image computer (processor) of module 600, certain particles from the natural flight path 12 and bring them into the container 70 of fraction B, whereas fraction A lands in container 80 along flight path 12. The plurality of integrated camera and lighting modules 100 are arranged adjacent to each other with each camera 200 having an image width that is smaller than the width of the bulk material stream.

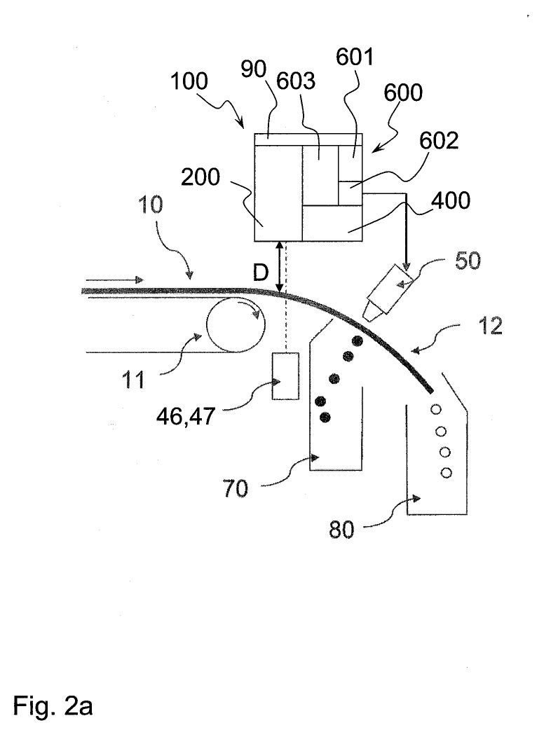

FIG. 3 shows as an example the sorting of a bulk material stream consisting of waste wood particles 10 into the two fractions:
B: unsuitable particles 14 because painted,
B: unsuitable particles 15 because consisting of rotted wood,
A: suitable particles 13 of healthy wood.
   The integrated camera and lighting module 100 is shown with a lighting means 400 comprising replaceable lighting units 42, 43 and 44 connected by a carrier 41. The carrier may include motor drives, wherein lighting units 42, 43 and 44 of the camera and lighting modules 100 are set up to be adjusted by the motor drives. The replaceable lighting units 42, 43 and 44 comprise, for example, three narrow-band linear LED lights each with respective projection optical systems of their own. The lighting units 42, 43 and 44 light the bulk material stream both as directed light (lighting units 42 and 43) and with diffusely emitted light (lighting unit 44). The illuminated area is imaged with an imaging optical system 21 onto a line of the dot matrix image sensor or camera 200.

The LED lights are briefly actuated in a pulsed manner in the line cycle of the sensor, so that this image line detects, consecutively in time, closely adjacent linear details of the bulk material stream, lit each time with the specific lighting means 42, 43 or 44 (time multiplex).

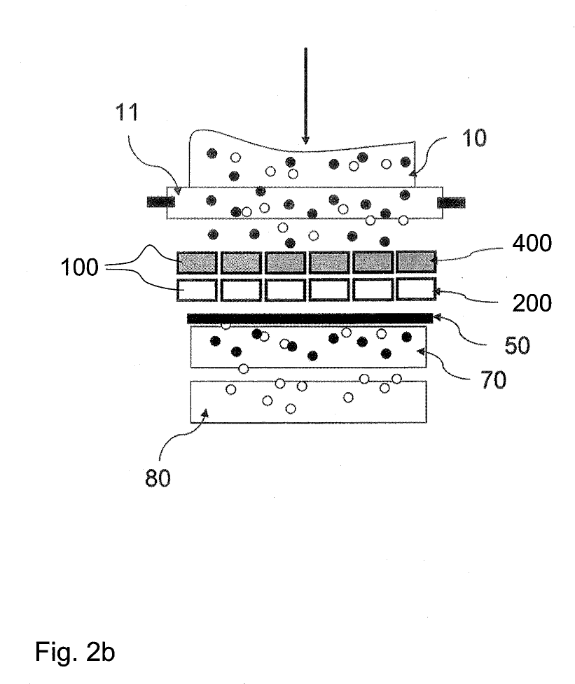

FIG. 4a, FIG. 4b and FIG. 4c show as examples the separation of the three types of particles of interest through a combination of optical effects, which are brought about by the different types of lighting. In this case the lighting means 400 has one or more different types of light units such as structured linear lighting unit 31, directed linear lighting unit 33 and narrow-band lighting unit 34.

FIG. 4a shows healthy, uncoated soft wood 13, which appears as a sequence of blurred dots 32 in case of lighting with a structured linear lighting means 31 formed by bright dots based on the halo effect (cf., e.g., EP 1 729 115 A2 which is incorporated herein by reference). The dot pattern from structured linear lighting means 31 remains sharp in case of a painted surface 14.

In FIG. 4b, painted particles 14 appear under a directed linear lighting means 33 as a bright, mirror-like reflection as shown reflection I(x), whereas natural wood and rotted wood appear as a dark line as shown. This can be recognized in FIG. 4b from the fact that the intensity I(x) of the particles 13 is markedly lower than that of particle 14. Melamine-coated particles, e.g., of laminate floor coverings, can be recognized from the broad-band fluorescence of the melamine resins that is generated with the use of a narrow-band lighting means 34 in the near UV range (FIG. 4c). The wood grain appears as a low-frequency texture rich in contrast (left-hand curve in FIG. 4c) in narrow-band light in the blue range, whereas rotted parts are visible as a low-contrast noise.

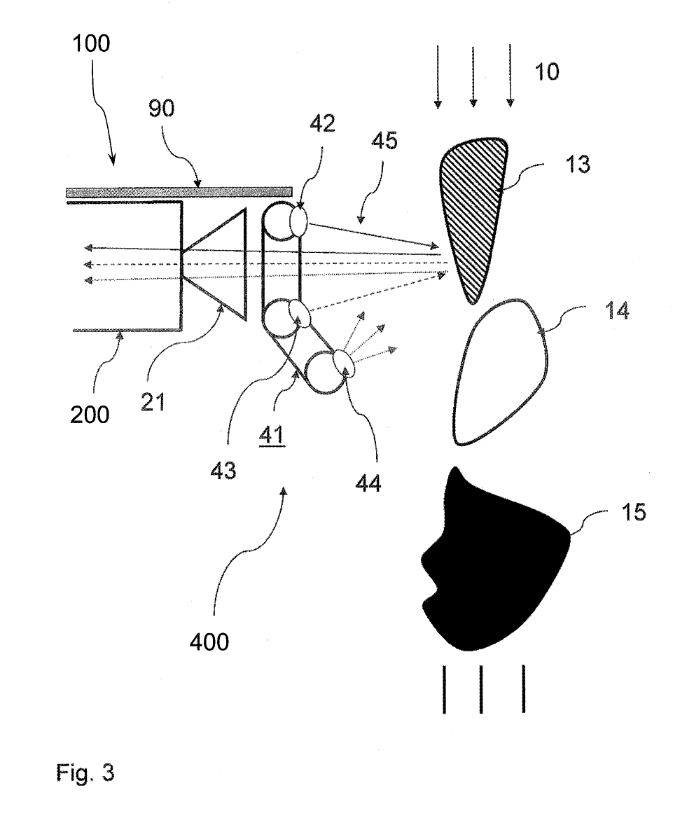

FIG. 5 illustrates the pulsed lighting diagram of the bulk material stream by rapid switching synchronized with the line cycle of the camera between the three lighting sources 42 (structured narrow-band lighting), lighting source 43 (directed narrow-band lighting) and lighting source 44 (short-wave, narrow-band lighting). This diagram, in which only one lighting source is activated at any time, will hereinafter be called “exclusive line multiplex lighting.” Providing that the particles are markedly larger in the direction of motion than one image line on the image sensor and are moving very fast, it can be approximately assumed that all three lighting means light approximately the same site of the particle despite the fact that the lighting pulses are offset from each other in time.

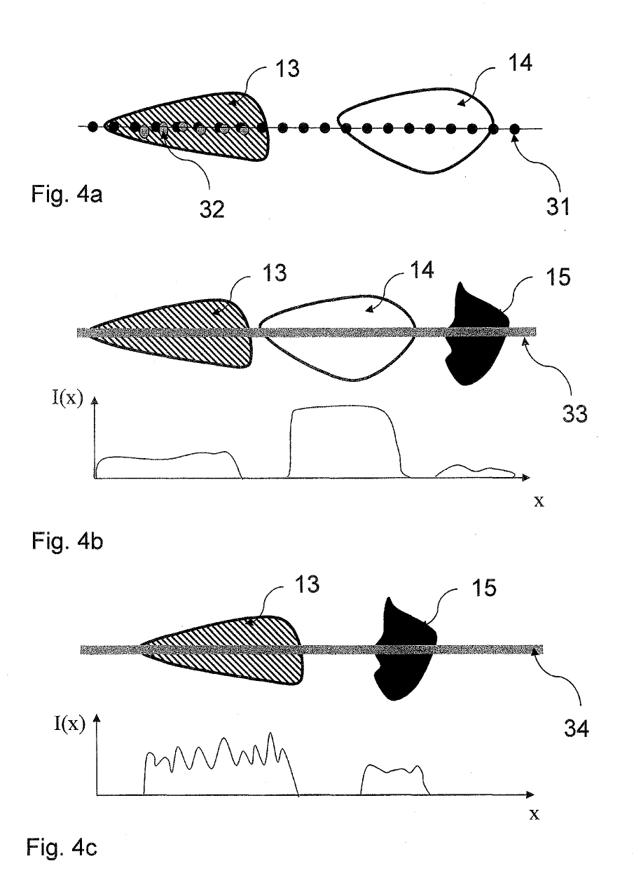

FIG. 6 illustrates an alternative lighting diagram, in which, for example, the two non-structured lighting means 43 and 44 light the image line of the line sensor and the lighting by the structured lighting means 42 takes place in the next scanning line, so that the scanning of the bulk material stream takes place, on the whole, with a 30% higher spatial resolution (mixed line/time-multiplex lighting).

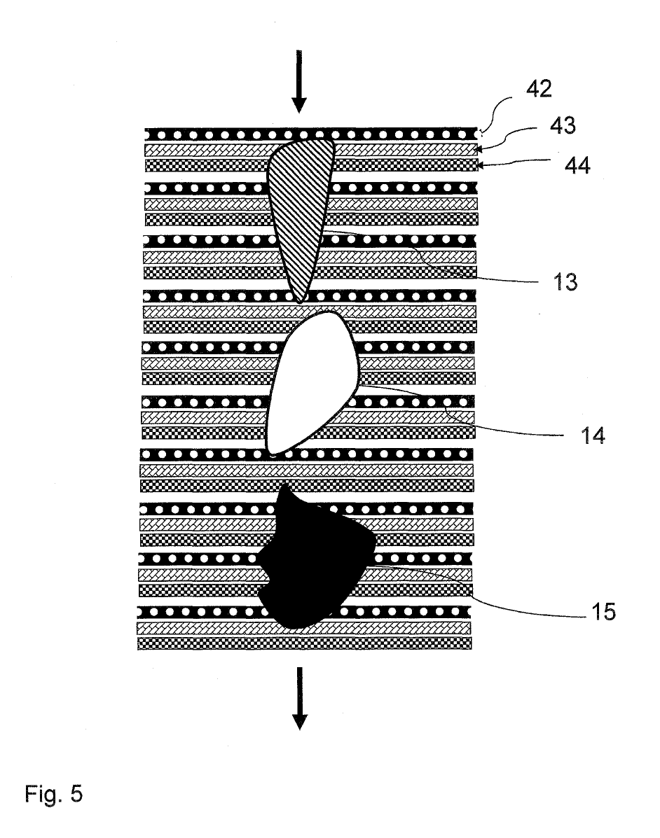

FIG. 7 illustrates the concept of the “optically maximally discriminating lighting intensities” according to the present invention, i.e., a method for the best separation of the fractions to be separated from each other and from the background by pulsed, narrow-band lighting means by the fact that, for example, the pulsed, non-structured, narrow-band lighting means 43 and 44 lighting both the image scene during the 10-μsec lighting window and the amplitude I(t) of the lighting means 43 is set, for example, at 50% of the amplitude I(t) of lighting means 43, so that the contrast between the fractions to be separated is maximized in the 1-channel line image with the duration of 100 μsec. The necessary difference of the lighting intensities can be set, for example, corresponding to the main components of the eigenvectors of the N-dimensional signal space, which is defined by the two lighting means 43 and 44, and therefore N=2 in this example.

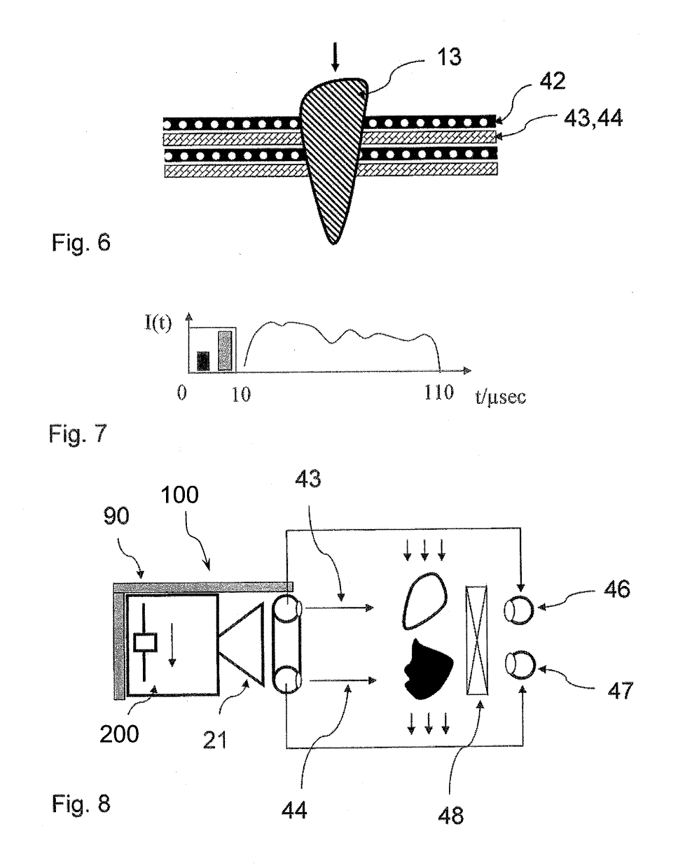

FIG. 8 illustrates the concept of the “optically maximally discriminating active background” according to the present invention, i.e., the fact that the fractions of the bulk material stream are best separated from each other and the background by a background lighting means 46 and 47, which is synchronized with the pulsed narrow-band incident-light lighting means 43 and 44 and whose wavelength ranges are selected to be such that the fractions that are not to be predominantly detected by the particular active lighting means show the lowest possible contrast, being switched on with each pulsed narrow-band incident-light lighting means 43 and 44. Both background lighting means can be advantageously brought to an equal distance from the camera via a diffuser 48 (for example, a diffusing lens).

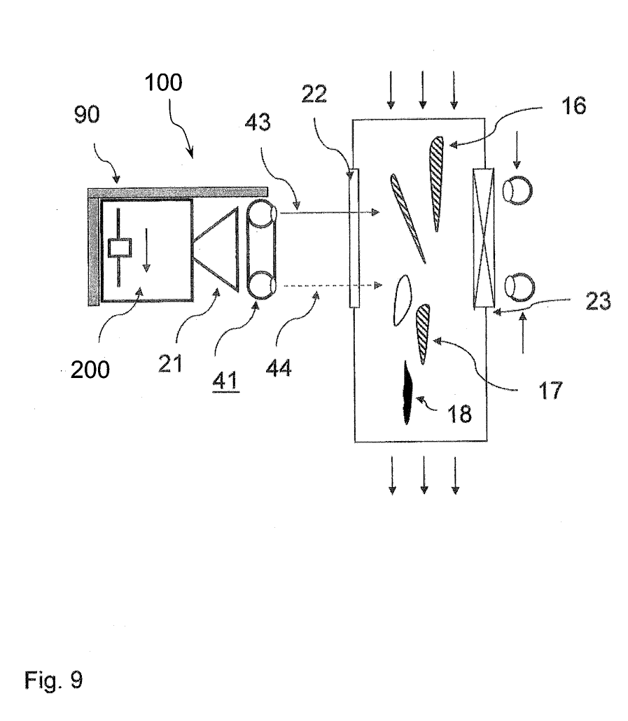

FIG. 9 illustrates generic aspects of the present invention, i.e., a simple camera and lighting module, which is only minimally changed, for adaptation to different material streams and sorting tasks, for example, to the recognition and sorting out of contaminants 17 (plastic parts) and 18 (jute twines) here in the stream of cotton fibers 16, which are detected pneumatically in an air duct with an observation window 22 and with an optical background 23 by the respective camera and lighting module 20 and 40 during their flight.

These optical effects described, for example, for discriminating the “soft wood,” “painted wood” and “rotted wood” fractions shall be considered to be an example only. The literature on wood inspection knows numerous other optical effects, which are suitable for use as optical characteristics for separating fractions. It is not the task of the present invention to describe a catalog of such features but to explain the basic inventive idea of the array and the process for a cost-effective optical screen.

Thus, the invention provides a highly modular and flexible camera and lighting system for the especially cost-effective inspection and sorting of numerous different types of bulk material streams with a uniform modular, generic system concept. The special and clear example of the sorting of wood particles within the framework of recycling waste wood and the production of high-quality particles, from which boards that are nearly as new can be produced, which example represents the principles of the process and of the array for carrying out the process according to the present invention in an especially simple and clear manner, is suitable for this.

FIG. 2b shows in a top view, the general design of an optical inspection and sorting system designed according to the inventive idea for sorting, for example, two fractions of particles. The system includes a feed means 11 for the particles 10, which are separated from one another. The plurality of modules 100 are adjacent to each other to provide a large number of line scan inspection cameras 200, which are arranged next to each other and which always observe only a small section of the bulk material stream in the incident light of a short linear lighting means 400 associated with such camera 200. An array of, for example, pneumatic ejectors 50 are arranged closely adjacent to one another in a line and are actuated by the image computer (processor and control) 600. The ejectors deflect certain selected particles from the natural path 12 and bring the particles into container 70 of fraction B, whereas fraction A lands in container 80 along the path 12.

It can be easily recognized from FIG. 2b that all overall sizes become smaller as a consequence of the substantially smaller image field per module 100.
The distance between the camera and lighting module and the path of the bulk material stream becomes smaller (FIG. 2a). This makes it possible to reduce the installed light output, and less expensive, less corrected imaging lenses make it possible to reduce the size of the individual lighting elements and thus to make the heat balance thereof simpler.
The arrangement of many camera and lighting element modules 100 of the same type is especially cost-effective because of the economy of scale. An adaptation to different material streams and sorting tasks is limited in the hardware to a simple adaptation of the lighting systems, which can be achieved, for example, by replacing the complete lighting module associated with the camera.

FIG. 3 illustrates the aspects of the invention as an example on the basis of the sorting of a bulk material stream of waste wood particles 10 for obtaining particles that are suitable for manufacturing high-quality wood boards from recycled wood obtained from demolition. The task is, for example, to separate the particles 10 into the two fractions:
B: particles 14 that are unsuitable for manufacturing boards because they are painted,
B: particles 15 unsuitable for manufacturing boards because they are rotted, and
A: particles 13 that are suitable for manufacturing boards because they consist of healthy wood.
   To do this a plurality of integrated camera and lighting modules 100 are provided, each with a camera 200 and a lighting means 400. A replaceable lighting means carrier 90 supports three narrow-band linear LED lights with projection optical systems or three lighting units 42, 43 and 44. In particular the carrier 41 is connected to the lighting means carrier 90 which is connected to the camera 200. The lighting units 42, 43 and 44 light the bulk material stream both in a directed manner (42 and 43) and diffusely (43).

The lit scene is imaged with an imaging optical system 21 onto, for example, a line of an inexpensive dot matrix image sensor 200 or onto a line sensor of a line scan camera 200, these sensors 200 being monochromatic image sensors. The LED lights of the lighting units are actuated briefly in a pulsed manner in the line cycle of the sensor, so that this image line detects, one after another in time, closely adjacent linear details of the bulk material stream 10, always lit with the specific pulsed lighting means 42, 43 or 44 (time multiplex).

This schematic process outline shown in FIG. 3 makes it clear that the replaceable lighting units 42, 43 and 44 makes possible rapid and cost-effective adjustments to different bulk material streams by
a variation of the narrow-band wavelengths of the emitted light and of the output thereof (radiometric properties of the lighting),
changing the geometric arrangement of one or a plurality of lighting units in relation to the direction of view of the camera and the position in space of the path of the particles of the bulk material stream (geometric properties of the lighting unit), by changing the number of lighting units used, and by changing the actuation in time compared to one another and to the line frequency of the camera (time-related properties, synchronization).

Despite the extensively identical mechanical design of the camera and lighting module 100, this arrangement according to the present invention leads to a highly modular generic sorting system, i.e., a system that can be adapted to a plurality of different tasks of bulk material stream inspection and sorting by making only a few simple changes.

FIG. 4a, FIG. 4b and FIG. 4c show as an example the separation of the three types of wood particles of interest by a combination of different optical effects, which are brought about by the different types of lighting:
healthy uncoated soft wood 13 appears as a sequence of blurred dots 32 based on the halo effect (cf., e.g., EP 1 729 115 A2) in case of lighting with a “structured” linear lighting unit 31 formed by bright dots, whereas the dot pattern remains sharp in case of a painted surface 14. The presence of the “GOOD” fraction can thus be recognized by means of simple image processing operations such as the one-dimensional local image sharpness along the image line. Painted particles bring about a bright, mirror-like reflection of high intensity I(x) under a directed linear lighting means 33, whereas natural wood and rotted wood appear as a dark line. Made easily identifiable in FIG. 4b by the fact that the intensity of the particles 13 and 15 is markedly lower than that of particles 14.

The wood grain appears under narrow-band lighting in the blue range as a locally periodic, low-frequency texture rich in contrast (curve on the left-hand side of FIG. 4c), whereas rotted parts appear as low-contrast noise (see FIG. 4c).

It is known to the person skilled in the art of pattern recognition, especially mechanical learning, that an optimal selection of all radiometric, geometric and time-related properties of the camera and lighting module can be systematically determined for a given sorting task on the basis of a sufficient number of “good” and “bad” samples of a bulk material stream to be sorted.

As to the question of which specific optical effects generated by the lighting are most suitable, for which material stream and for which specific sorting tasks, this may be considered based on known information. Reference can be made to the literature of pattern recognition and of mechanical learning.

FIG. 5 illustrates the pulsed lighting diagram of the bulk material stream by a fast switching synchronized with the line cycle of the camera between the three lighting sources 42 (structured, narrow-band lighting), lighting source 43 (directed, narrow-band lighting) and lighting source 44 (diffuse short-wave, narrow-band lighting). This diagram, in which only one individual lighting source is always activated for a line period of the image sensor, is referred to as the “exclusive line multiplex lighting.” Providing that the particles are markedly larger than an object line and the bulk material stream is moving fast, it can be approximately assumed that all three lighting means light approximately the same site of the particle, i.e., that the three line images generated one after another detect approximately the same site of the particle, lit with another lighting source each time. The higher the line frequency (and, associated with this, the frequency with which switching is performed between the three lightings), the better is this approximation of the scanning of the same site satisfied.

FIG. 6 illustrates an alternative lighting diagram according to the present invention, in which the changes are limited to the electronic synchronization of the line image sensor and lighting sources only. The two non-structured lighting units 43 and 44 light, for example, the image line of the line sensor simultaneously in a first line cycle and the lighting by the structured lighting units 42 takes place in the next line cycle. Since the two wavelength ranges are designed for different effects, for example, lighting unit 44 in the near UV range for the color-independent recognition of rotted sites and the directed lighting unit 43 in the near infrared range for the color-independent visualization of mirror-like reflecting painted surfaces, it can be recognized from the superimposed image whether the particle in question is a “GOOD” particle or not, without the image sensor having to have expensive spectral filters. Compared to the “exclusive line multiplex lighting,” this light diagram brings about scanning of the bulk material stream with a 30% higher spatial resolution (“mixed line/multiplex lighting”).

FIG. 7 illustrates the concept of “optically maximally discriminating lighting intensities” according to the present invention, i.e., a process and an arrangement for best separating the fractions to be separated both from each other and from the background by pulsed narrow-band lighting unit. Separation from the background is necessary, e.g., if the shape and size of the particles must be measured. This is achieved by, for example, the pulsed, non-structured narrow-band lighting units 43 and 44 lighting the image scene simultaneously or one shortly after the other during the 10-μsec lighting window of the line sensor and by the amplitude I(t) of the lighting unit 43 and of the lighting unit 44 being set differently. For example, the output of lighting unit 43 shall be set at only 50% of the power of lighting unit 44, so that the contrast between the fractions to be separated is maximized in the 1-channel line image generated with the reading time of 100 μsec because the optical effect may be twice as pronounced in case of lighting unit 43 as the optical effect of lighting unit 44. This lighting process according to the present invention therefore generates a line signal, which corresponds to the weighted sum of the reflections with the different lightings.

Another feature of the invention is that the emitted lighting intensity is not changed by varying the amplitude of the lighting, but by a fine change of the duration of the lighting pulse in the exemplary lighting window of the line sensor. Due to the integration of the photodetectors over time (especially pronounced in the CCD technique), a longer lighting time at a given amplitude is equivalent to a shorter lighting time at a correspondingly higher amplitude.

The necessary difference of the lighting intensities can be determined by tests but it may also be derived systematically by their being set, for example, corresponding to the main components of the eigenvectors of the N-dimensional signal space, which is defined by the two lighting unit 43 and 44.

FIG. 8 illustrates the inventive feature of the optically maximally discriminating active background. The fractions of the bulk material stream are best separated from each other and the background by a background lighting means comprising background lighting units 46 and 47 pulsed synchronously with each pulsed narrow-band incident-light lighting units 43 and 44 being switched on, the wavelength ranges of said background lighting units 46 and 47 being selected to be such that the fractions that are predominantly not to be detected by the respective active lighting units have the lowest possible contrast from the active background. Both background lighting units can be advantageously brought to an equal distance from the camera via a diffuser 48 (for example, diffusing lens).

The significance of an optically fitting background has been known for a long time. For the optical sorting of rice grains, the background is traditionally formed by colored cardboard, whose color corresponds to the “GOOD” rice grain. The “GOOD” fraction is thus optically masked. This process is not flexible and requires a considerable mechanical intervention in case of a changeover from one product to another.

It is described in DE 20 2006 016 604 U1 that the background is formed for a bulk material stream system with color cameras by a LED lighting system, which can be set in terms of color and brightness to the color and brightness of a fraction and which thus makes this fraction invisible. This background is static, i.e., it does not change with the reading cycle of the color camera.

Contrary to this known state of the art, the concept according to the present invention is directed to the observation of bulk material streams with monochromatic image sensors and pulsed, narrow-band lighting units as well as synchronously pulsed background lights associated therewith. It is thus possible to generate the optimal optical background purely electronically for each incident light source in a short time in the rapid succession of the line cycle and thus to highlight especially the shape of the fractions to be sorted out with a strong contrast in the line image of all types of lighting used.

However, the idea according to the present invention also describes, in particular, a “generic” process, i.e., a process and an arrangement which can be changed over to entirely different material streams and sorting tasks with only a few, simple mechanical optical changes.

FIG. 9 shows, for example, in a side view, the few hardware modifications that are necessary for achieving the sorting out of foreign materials in cotton being conveyed pneumatically from the sorting of wood particles. Ejector signals shall be generated in the example by the optical detection and discrimination of the three fractions cotton fiber 16, contaminating plastic parts 17 and contaminating jute twines 18 in order to blow out the contaminants. The air stream flowing in a transport duct is lit alternatingly in a pulsed manner via a transparent window 22 with two narrow-band linear lights in the range of λ1=405 nm and λ2=850 nm and detected as an image with the line sensor 20. For better discrimination, the background 23 is generated according to the present invention by pulsed lighting sources such that it forms the greatest contrast possible between the cotton fibers and the contaminants at both wavelengths (cf. the second document cited: “Detection of foreign materials in cotton using a multi-wavelength imaging method,” Meas. Sci. Technol. 16, pp. 1355-1362, Institute of Physics Publishing 2005).

The mechanical optical changes are therefore limited essentially to the design of the lighting (other wavelengths, only directed).

The idea proper of the present invention is that the novel combination of arrangements and processes for the optical sorting of bulk material streams, which are known in themselves, leads to a generic, highly modular, robust system, which is very inexpensive due to the reduced overall size, contrary to the current, very large and expensive systems, which can be maintained in a stable condition with difficulty only in a harsh industrial environment and are highly specialized to a single task or to only a small number of tasks.

While specific embodiments of the invention have been shown and described in detail to illustrate the application of the principles of the invention, it will be understood that the invention may be embodied otherwise without departing from such principles.

What is claimed is:

1. A multisensor array for optical inspection and sorting of bulk materials into different fractions, in which the bulk material stream is detected from a short distance compared to the width of the stream of bulk material, the multisensor array comprising:
a camera arrangement comprising two identical camera and lighting modules arranged adjacent to each other, wherein the width of the image of each of the cameras is smaller than the width of the bulk material stream, each of the camera and lighting modules comprise image sensors and a lighting components limited to a wavelength range of 380 nm to 1,000 nm covered by CMOS and/or CCD image sensors, each camera and lighting module comprising a camera connected by a mechanical bracket to an associated set of linearly lighting semiconductor light sources which emit in a narrow band and are pulsed synchronously with a line frequency of the associated camera, wherein the linearly lighting light sources can be replaced by means of a changing mechanism of the bracket, which said mechanism is connected to the camera, to other light sources, especially to ones having different system parameters, and wherein the actuating signals of the lighting sources pulsed synchronously with the line cycle of the image sensors are generated by means of an electronic means according to a variable optimization diagram, which can be optimized for the discrimination of the fractions of the bulk material stream;
an image computer analyzing signals of the camera arrangement by pattern recognition and classification for recognizing, assigning and rating the bulk material component particles of different fractions;
a control device generating timely ejection signals based on real-time image processing operators in order to remove particles of at least one fraction to be separated from the bulk material stream with ejectors.

2. An array in accordance with claim 1, further comprising a background lighting means for providing pulsed background lighting synchronously with incident lighting associated with each camera and lighting module, wherein the wavelength ranges of the incident-light and background lighting means are selected to be such that a contrast against the background is minimized for the fractions that are not to be separated.

3. An array in accordance with claim 1, further comprising a number of ejectors arranged next to each other in a line, the ejectors being associated with each camera and lighting module and the ejectors being actuated by signals of the camera and lighting module.

4. An array in accordance with claim 1, further comprising motor drives wherein lighting components of the camera and lighting modules are set up to be adjusted by motor drives.

5. An array in accordance with claim 1, wherein the modules provide sensors and computer interfaces to poll characteristics, position in space and orientation in space of the linear lighting means associated with one camera by means of an electronic computing unit.

6. A process for optical inspection and sorting of bulk materials into different fractions, the process comprising the steps of:
providing a plurality of identical camera and lighting modules, each of the camera and lighting modules including a lighting means and a camera having an image sensor having an image width that is smaller than a width of the bulk material stream wherein each camera and each lighting means are limited to a wavelength range of 380 nm to 1,000 nm covered by CMOS and/or CCD image sensors;
arranging the camera and lighting modules adjacent to each other with each camera covering only a partial detail of the bulk material stream and with each camera pointed in a direction at right angles to the direction of the bulk material stream;
providing a plurality of mechanical brackets with each of the mechanical brackets being associated with one of the camera and lighting modules;
connecting each camera and each lighting means to one of the mechanical brackets wherein each lighting means comprises one or a set of linearly lighting semiconductor light sources, which emit in a narrow band and are pulsed synchronously with the line frequency of the camera, and the bracket makes it possible to replace the linearly lighting light sources with light sources having different system parameters;
detecting the bulk material stream with the camera and lighting modules from a short distance compared to the width of the bulk material stream;
generating actuating signals of the lighting sources pulsed synchronously with the line cycle of the image sensors via an electronic means for discriminating the fractions of the bulk material stream according to a variable synchronization diagram, which is optimized for the discrimination of the fractions of the bulk material stream;
analyzing the signals of the camera or of the cameras by means of at least one image processor with pattern recognition methods;
classifying and rating the components of the bulk material;
generating ejection signals by means of real-time image processing operators to sort out the fractions to be removed from the bulk material stream by means of ejectors.

7. A process for the optical sorting of bulk material streams in accordance with claim 6, wherein the pattern recognition methods as well as the lighting arrangements and lighting actuating means of the electronic means are determined and optimized for the inspection and sorting task set in a preparatory learning phase on the basis of samples of the bulk material stream by means of methods of mechanical learning and pattern recognition.

8. A process for the optical sorting of bulk material streams in accordance with claim 6, wherein:
each camera is a the line scan camera; and
at least two of the pulsed lighting means operating at different wavelengths are operating with different light pulse outputs, the pulsed lighting means having a power ratio selected to be such that a radiometric separation of the fractions takes place in an image signal of the line scan camera with the highest possible discrimination.

9. A process for the optical sorting of bulk material streams in accordance with claim 6, wherein the power ratio corresponds to the ratio of the characteristic values of the signal space defined by the at least two line image signals.

10. A process for the optical sorting of bulk material streams in accordance with claim 6, wherein at least two of the pulsed lighting means are triggered in the same lighting time window of the line sensor.

11. A multisensor array system for optical inspection and sorting of bulk materials of a bulk material stream into different fractions, the system comprising:
a plurality of identical camera and lighting modules, each of the camera and lighting modules including a lighting means and a camera having an image sensor having an image width that is smaller than a width of the bulk material stream wherein each camera and each lighting means has a wavelength range of 380 nm to 1,000 nm, the camera and lighting modules being arranged adjacent to each other with each camera covering only a partial detail of the bulk material stream and with each camera pointed in a direction at right angles to the direction of the bulk material stream;
a plurality of mechanical brackets with each of the mechanical brackets associated with one of the camera and lighting modules, each camera and each lighting means being connected to one of the mechanical brackets wherein each lighting means comprises one or a set of semiconductor lighting units and the bracket provides connection and disconnection means to replace the light units with light units having different characteristics;
an electronic means including lighting actuating means generating actuating signals of the lighting sources pulsed synchronously with a line frequency of the camera, an image processor analyzing signals of the camera or of the cameras with pattern recognition methods and classifying and rating the components of the bulk material; and
a control device generating ejection signals based on real-time image processing operations of the image processor to sort out the fractions to be removed from the bulk material stream

12. A multisensor array system in accordance with claim 11, further comprising a background lighting means for providing pulsed background lighting synchronously with incident lighting of the lighting units associated with each camera and lighting module, wherein the wavelength ranges of incident-light and of the background lighting means are selected to be such that a contrast against the background is minimized for the fractions that are not to be separated.

13. A multisensor array system in accordance with claim 11, further comprising a plurality of ejectors arranged next to each other in a line, wherein:
each camera and lighting module includes an associated said electronic means, image processor and control device;
each of the ejectors is associated with one of the camera and lighting modules; and
the ejectors are actuated by signals from the control unit of each associated camera and lighting module.

14. A multisensor array system in accordance with claim 11, further comprising motor drives wherein lighting components of the camera and lighting modules are set up to be adjusted by motor drives.

15. A multisensor array system in accordance with claim 14, wherein each of the camera and lighting modules poll characteristics, position in space and orientation in space of the associated lighting means associated the image processor or another processor of the respective camera and lighting module.

16. A multisensor array system in accordance with claim 6, wherein the electronic means provides lighting actuating signals for discriminating the fractions of the bulk material stream according to a variable synchronization diagram, which is optimized for the discrimination of the fractions of the bulk material stream in a preparatory learning phase on the basis of samples of the bulk material stream by means of mechanical learning and pattern recognition.

17. A multisensor array system in accordance with claim 11, wherein:
each camera is a the line scan camera; and
at least two of the pulsed lighting means operating at different wavelengths are operating with different light pulse outputs, the pulsed lighting means having a power ratio selected to be such that a radiometric separation of the fractions takes place in an image signal of the line scan camera with the highest possible discrimination; and
the power ratio corresponds to the ratio of the characteristic values of the signal space defined by the at least two line image signals.

18. A multisensor array system in accordance with claim 11, wherein:
each camera is a the line scan camera;
at least two of the pulsed lighting units of the lighting means operate at different wavelengths; and
at least two of the pulsed lighting means are triggered in the same lighting time window of a line sensor of each line scan camera.

19. A multisensor array system in accordance with claim 11, wherein:
each of the camera and lighting modules includes one said electronic means, one said processor and one said control unit.

20. A multisensor array system in accordance with claim 11, wherein:
a distance of the camera of each of the camera and lighting modules from the bulk material stream is smaller than a width of the bulk material stream.
